(19) United States
(12) Patent Application Publication
(10) Pub. No.: US 2024/0109130 A1
(43) Pub. Date: Apr. 4, 2024

(54) Chip Former Apparatus and Method

(71) Applicants: Rodrigo Ramirez, Tomball, TX (US); James L. Caldwell, JR., Tomball, TX (US)

(72) Inventors: Rodrigo Ramirez, Tomball, TX (US); James L. Caldwell, JR., Tomball, TX (US)

(21) Appl. No.: 17/955,645

(22) Filed: Sep. 29, 2022

(51) Int. Cl. B23B 27/06

(52) U.S. Cl. CPC B23B 27/065; B23B 2270/30

(57) ABSTRACT

A chip former for directing material cut from a workpiece. The chip former having a body with a top side, a bottom side, a front side, and a back side. The front side consists of a surface forming a wall with a section of the surface having a concave geometry configured to direct material that comes off a workpiece. A method for directing material cut from a workpiece.

### CROSS REFERENCE TO RELATED APPLICATIONS

Not applicable.

### FIELD OF THE INVENTION

This disclosure relates generally to apparatus and methods for controlling and directing material cut from a workpiece on a lathe device, and more particularly to a chip former used therefore.

### BACKGROUND

Threading of a workpiece is conventionally performed using a precision ground flat-face threading insert. As used herein for purposes of this disclosure, the word “threading” is not to be limited to any particular operation on a workpiece: it is meant to encompass any process conventionally performed on a workpiece (e.g., thread forming, groove forming, material removal, etc.). The conventional threading insert is used in conjunction with an adjoining, separate, inclined-surface mechanical chip breaker. The threading insert and mechanical chip breaker are generally seated in a pocket of a toolholder for providing selected engagement with respect to a workpiece on a lathe to thereby provide it with threads. FIG. 1 shows a conventional threading bar 10 with an insert 11, a support block 12, a chip breaker 13 with a straight-edge inclined face 14, a turning workpiece 15, and the “stringer” 16 being formed from the material as it is cut off the workpiece.

As shown in FIG. 1, conventional chip breakers 13 have a straight-edge inclined face 14 that produces a stringer 16 of material that can go in any direction. As the insert 11 enters the workpiece 15 material and moves the desired length horizontally it generally takes light cuts, producing a thin trail of material that doesn't break. The string of material runs over the straight-edge inclined face 14 and goes wildly in any direction. Many times this material stringer 16 will wrap around the threading bar 10, ball up in the coupling ID or get stuck on the machine spindle. In all cases, the machine operator must deal with the stringer 16 before running the next part. This can take anywhere from a few seconds to minutes depending on how long the operator lets the condition continue. In addition to lost machine time, this stringer 16 drastically reduces tool life as it gets in the way of the process and chips the threading insert 11, especially when performing internal threading (e.g., box or female pipe connection ID). The stringer 11 also presents a safety hazard for the operator as it grows into a mass and whips around, requiring the operator to remove it by hand or with a hook.

Thus, a need remains for improved techniques to safely and efficiently control and direct material as it is cut from and comes off a workpiece.

### SUMMARY

According to an aspect of the invention, a chip former for directing material cut from a workpiece includes a body having a top side, a bottom side, a front side, and a back side. The front side of the body consists of a surface forming a wall with a section of the surface having a concave geometry configured to direct material that comes off a workpiece.

According to another aspect of the invention, a method for directing material cut from a workpiece includes disposing a chip former in proximity to material coming off a workpiece, the chip former having a body with a top side, a bottom side, a front side, and a back side. The front side of the body consisting of a surface forming a wall with a section of the surface having a concave geometry. And accumulating material at the front side of the chip former body as the material comes off the workpiece.

According to another aspect of the invention, a method for directing material from a workpiece includes disposing a chip former in proximity to a workpiece to receive material coming off the workpiece, the chip former having a body with a top side, a bottom side, a front side, and a back side. The front side of the body consisting of a surface forming a wall with a section of the surface having a concave geometry configured to direct the material coming off the workpiece.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows a cross section of a conventional chip breaker as used in conjunction with a conventional insert to remove material from a turning workpiece.

FIG. 2 shows a perspective view of a chip former according to an example of the present disclosure.

FIG. 3 shows a side view of another chip former according to an example of the present disclosure.

FIG. 4 shows a bottom view of another chip former according to an example of the present disclosure.

FIG. 5 shows a perspective view of another chip former according to an example of the present disclosure.

FIG. 6 shows a side view of another chip former according to an example of the present disclosure.

FIG. 7 shows a perspective view of another chip former according to an example of the present disclosure.

FIG. 8 shows a cross section of a chip former in operation according to an example of the present disclosure.

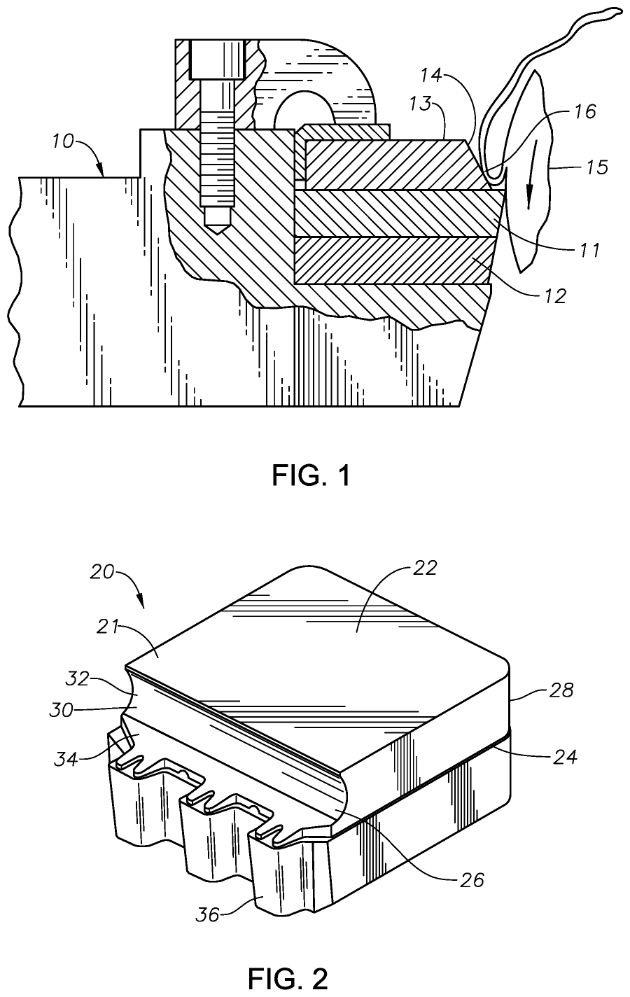

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness. In the development of any actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure. The following detailed description of exemplary embodiments, read in conjunction with the accompanying drawings, is merely illustrative and is not to be taken as limiting the scope of the invention.

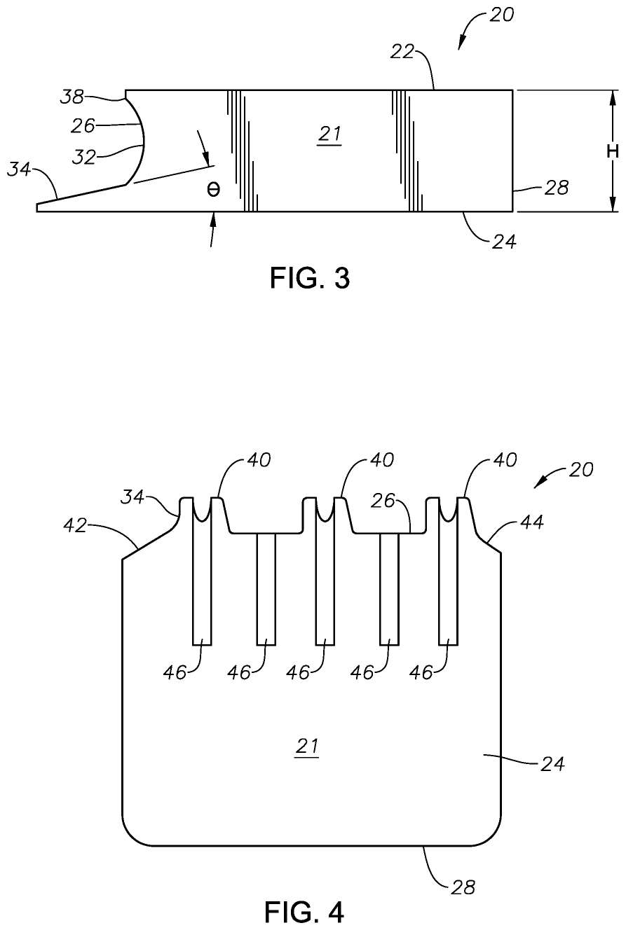

FIG. 2 shows an embodiment of a chip former 20 according to this disclosure. Embodiments of the chip former generally have a body 21 with a top side 22, a bottom side 24, a front side 26, and a back side 28. The front side 26 of the body 21 forms a walled surface 30 across the entire width of the body, with a section 32 of the walled surface 30 having a concave geometry (depicted in FIG. 3). The front side 26 of the body 21 extends from the bottom outward to form a ramp 34 sloping at an angle from the bottom side 24 and terminating at the walled surface 30. As shown in FIG. 2, the chip former 20 is configured for placement beside a conventional insert 36.

It will be appreciated by those skilled in the art that the body 21 may be formed of any suitable material (e.g., hardened steel, metal alloys, etc.) to handle the material of the workpiece being cut. Although the chip former 20 embodiment in FIG. 2 is shown formed with a body 21 shaped as a quadrilateral puck, it will be appreciated that other chip former embodiments may be formed in other shapes (e.g., half-moon, V-shaped, etc.).

FIG. 3 shows a schematic side view of a chip former 20 embodiment according to this disclosure. As shown in FIG. 3, some chip former 20 embodiments are formed with the walled surface 30 at the front side 26 of the body 21 having an arced concave surface. Embodiments may also be configured with the walled surface 30 having a curved protrusion 38 extending from the top side 22 where the front side 26 adjoins with the top side of the body 21. The curved protrusion 38 aids in controlling and directing material cut from a workpiece, as further described below. Chip former 20 embodiments may be formed in various heights H (e.g., ranging between 0.125-0.75 inches (3.175-19.05 mm) between the top side 22 and the bottom side 24. Embodiments may also be implemented with a ramp 34 sloping at different angles θ(e.g., ranging between 0-40 degrees) from the bottom side 24.

FIG. 4 shows a bottom view of a chip former 20 embodiment according to this disclosure. As shown in FIG. 4, some chip former 20 embodiments are implemented with the ramp 34 having one or more peaks 40 formed across the width of the body 21. The peak(s) 40 are configured to match the contours on the insert 36 (see FIGS. 2, 5, 7) when the chip former 20 is placed adjacent to the insert in the typical threading bar arrangement as known in the art. The embodiment of FIG. 4 also includes a first incline 42 formed at a first end of the ramp 34 and a second incline 44 formed at a second end of the ramp opposite the first end. Some embodiments may also be implemented with one or more grooves 46 formed along the surface of the bottom side 24 of the body 21. The groove(s) 46 may be formed to run along the entire surface of bottom side 24 or along a shortened length (e.g., from the front side 26 stopping midway to the back side 28 as shown in FIG. 4). The groove(s) 46 aids in dissipating heat from the junction between the chip former 20 body 21 and the insert 36 as generated when the insert is cutting or removing material from a workpiece.

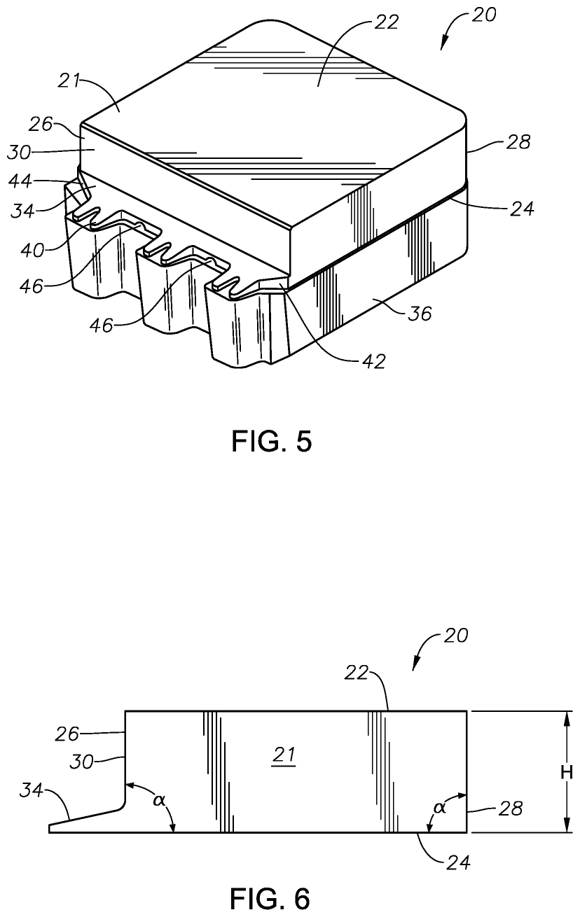

FIG. 5 shows another embodiment of a chip former 20 according to this disclosure. Some embodiments may be implemented with the walled surface 30 comprising a section of the surface at an angle of ninety degrees to the bottom side 24 of the body 21. FIG. 6 shows a side view of a chip former 20 embodiment implemented with the walled surface 30 formed parallel to the surface forming the back side 28 of the body 21, in this case both surfaces are configured at an angle ∝ of ninety degrees to the bottom side 24 of the body 21.

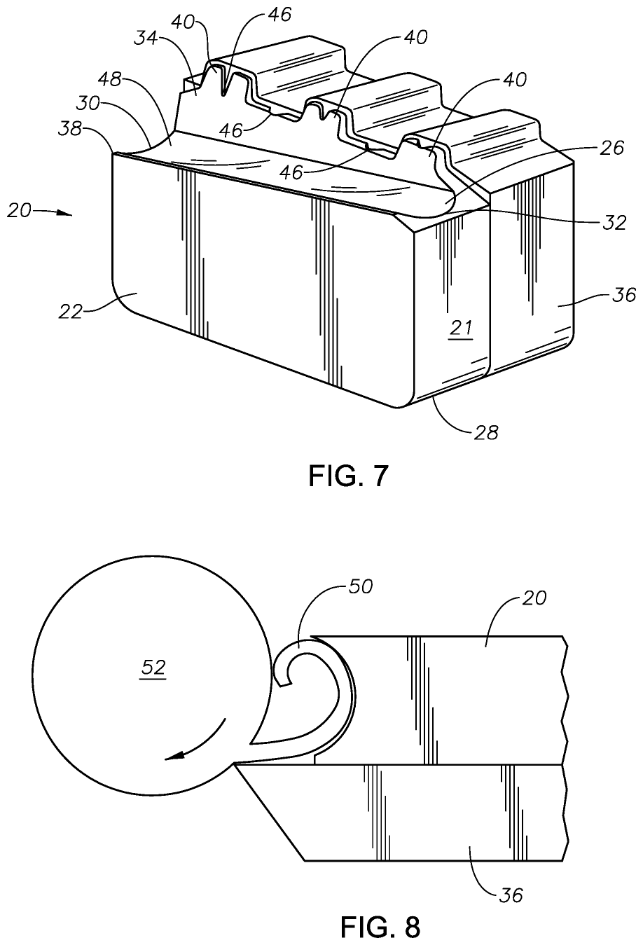

FIG. 7 shows another embodiment of a chip former 20 according to this disclosure. Some embodiments may be implemented with the walled surface 30 formed at an angled incline 48 running across the width of the body 21 from one side to the other side. In such embodiments, the ramp 34 varies in width as it extends out from the front side 26 of the chip former 20. Some embodiments may also be implemented with the inclined 48 walled surface 30 formed as a concave surface with a curved protrusion 38 extending from the top side 22 where the front side 26 adjoins with the top side of the body 21.

FIG. 8 shows a cross section schematic of a chip former 20 embodiment according to this disclosure in operation as it controls and directs a stringer 50 which is formed while threading a workpiece 52. As the insert 36 teeth cut material from the workpiece 52, the chip former 20 catches the material immediately as it comes off and directs it into a circular/spiral shaped stringer 50, which it continues in for the length of the thread pass. The stringer 50 forms into a “pig tail”, making it heavier, weighing it down, keeping it in a tight form to prevent from wrapping around the chuck or clogging the lathe components. The pig tail eventually falls off on its own due to its weight, where it is typically carried off on a conveyer belt.

Other embodiments may be implemented with the chip former 20 body 21 and the insert 36 formed as a unitary structure. For example, embodiments may be implemented with the chip former 20 permanently affixed to the insert 36 (e.g., via epoxies, fasteners, etc.). Some embodiments may be implemented with the chip former 20 body 21 and/or insert 36 pressed and sintered. Yet other embodiments may be implemented with the body 21 and the insert 36 formed as a unitary structure during formation (e.g., via water jet cutting, material deposition, etc.). Electrical discharge machining techniques may also be employed to produce the chip former 20 body 21 and/or insert 36 embodiments disclosed herein.

In light of the principles and example embodiments described and depicted herein, it will be recognized that the example embodiments can be modified in arrangement and detail without departing from such principles. It will be appreciated by those skilled in the art that embodiments of this disclosure may be implemented using conventional materials suitable for the desired application (e.g., components made of metal, hybrid composites, etc.). What is claimed as the invention, therefore, are all implementations that come within the scope of the following claims, and all equivalents to such implementations.

What is claimed is:

1. A chip former for directing material cut from a workpiece, comprising:
a body having a top side, a bottom side, a front side, and a back side,
wherein the front side consists of a surface forming a wall with a section of the surface having a concave geometry configured to direct material that comes off a workpiece.

2. The chip former of claim 1 wherein the front side includes a ramp sloping at an angle from an edge of the bottom side and terminating at the surface forming the wall.

3. The chip former of claim 1 further comprising at least one groove formed along a surface of the bottom side of the body.

4. The chip former of claim 2 wherein the ramp is configured with a first incline at a first end and a second incline at a second end opposite the first end.

5. The chip former of claim 2 wherein the ramp is configured with at least one peak formed thereon.

6. The chip former of claim 1 wherein the surface forming the wall at the front side of the body comprises a section at an angle of ninety degrees to the bottom side of the body.

7. The chip former of claim 1 wherein the body is configured for disposal proximate to an insert configured to cut material from the workpiece.

8. The chip former of claim 1 wherein the body is formed with a protrusion extending from an edge where the front side of the body adjoins with the top side of the body.

9. The chip former of claim 1 wherein the body is configured as a unitary structure with an insert for cutting material from the workpiece.

10. A method for directing material cut from a workpiece, comprising:
disposing a chip former in proximity to material coming off a workpiece, the chip former having a body with a top side, a bottom side, a front side, and a back side;
wherein the front side of the body consists of a surface forming a wall with a section of the surface having a concave geometry; and
accumulating material at the front side of the chip former body as the material comes off the workpiece.

11. The method for directing material of claim 10 wherein the front side of the body includes a ramp sloping at an angle from an edge of the bottom side of the body and terminating at the surface forming the wall.

12. The method for directing material of claim 10 wherein the bottom side of the body comprises at least one groove formed along a surface thereof.

13. The method for directing material of claim 11 wherein the ramp is configured with a first incline at a first end and a second incline at a second end opposite the first end.

14. The method for directing material of claim 11 wherein the ramp is configured with at least one peak formed thereon.

15. The method for directing material of claim 10 wherein the surface forming the wall at the front side of the body comprises a section at an angle of ninety degrees to the bottom side of the body.

16. The method for directing material of claim 10 wherein the chip former is disposed proximate to an insert configured to cut material from the workpiece.

17. The method for directing material of claim 10 wherein the chip former body is configured with a protrusion extending from an edge where the front side of the body adjoins with the top side of the body.

18. The method for directing material of claim 10 wherein the body is configured as a unitary structure with an insert for cutting material from the workpiece.

19. A method for directing material from a workpiece, comprising:
disposing a chip former in proximity to a workpiece to receive material coming off the workpiece, the chip former having a body with a top side, a bottom side, a front side, and a back side,
wherein the front side of the body consists of a surface forming a wall with a section of the surface having a concave geometry configured to direct the material coming off the workpiece.

20. The method for directing material of claim 19 wherein the body is configured with a protrusion extending from an edge where the front side of the body adjoins with the top side of the body.
